(19) United States
(12) Patent Application Publication
(10) Pub. No.: US 2024/0020773 A1
(43) Pub. Date: Jan. 18, 2024

(54) IDENTIFYING ENTERPRISE CONNECTIONS

(71) Applicant: VMWARE, INC., Palo Alto, CA (US)

(72) Inventor: Rohit Pradeep Shetty, Bangalore (IN)

(21) Appl. No.: 17/950,122

(22) Filed: Sep. 22, 2022

(30) Foreign Application Priority Data
Jul. 13, 2022 (IN) 202241040188

(51) Int. Cl. G06Q 50/00

(52) U.S. Cl. CPC G06Q 50/01

(57) ABSTRACT

Disclosed are various embodiments for identifying a connection to an external user or organization based upon analysis of data sources within an enterprise. User activity within communications applications can be assessed to identify a closest connection to the external user or organization based upon frequency of communication, age of communication, and/or a sentiment analysis.

### RELATED APPLICATIONS

Benefit is claimed under 35 U.S.C. 119(a)-(d) to Foreign Application Serial No. 202241040188 filed in India entitled “IDENTIFYING ENTERPRISE CONNECTIONS”, on Jul. 13, 2022, by VMware, Inc., which is herein incorporated in its entirety by reference for all purposes.

### BACKGROUND

In enterprise environments, users often collaborate with others who are external to the enterprise. For example, a user in a sales and marketing role might wish to contact and collaborate with new prospects in a different company. Oftentimes, having a common acquaintance can offer an advantage in communicating with a person external to the enterprise compared to cold calling the external user. A recommendation or introduction from a trusted or a common acquaintance increases the chances of a sales prospect being converted into sale.

In other contexts, users might need to interact with other contacts or external users in a different enterprise or organization to facilitate software development, joint development, contribute to open source projects, or perform other tasks and projects, users within an enterprise might need to interact with people or teams from other organizations external to the enterprise.

For example, a user or group within an enterprise might want to build an integration with a product released by a different company or build an extension atop a library released by an open-source organization. In both cases, the user can go through a formal route of reaching out to the company or organization of an external user. However, this requires time and may be unsuccessful. A common acquaintance can often speed or facilitate an introduction.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a diagram illustrating an example data flow according to various embodiments of the present disclosure.

FIG. 3 is a flowchart illustrating one example of functionality implemented as portions of an application executed in a computing environment in the networked environment of FIG. 1 according to various embodiments of the present disclosure.

### DETAILED DESCRIPTION

The present disclosure is related to generating a graph expressing connectedness between users in an enterprise directory and external users, or people who are external to the directory. In enterprise environments, users often collaborate with others who are external to the enterprise. For example, a user within an enterprise might wish to contact and collaborate with new prospects from a different company. Oftentimes, having a common acquaintance can offer an advantage in communicating with a person external to the enterprise. A recommendation or introduction from a trusted or a common acquaintance increases the chances of the connection being meaningful.

In many instances, users who receive unsolicited communications from unknown users external to their organization often ignore the communications. However, having a common acquaintance can increase the chances of the user responded to or acting on the unsolicited communication. While social networking systems offer a mechanism through which to connect users, these social networking systems do not rely upon assessing a connectedness between users based upon data sources that are unavailable to the social networking system.

Examples of the disclosure operate by analyzing data sources within an enterprise, such as emails, messaging, chats, conferencing, and other private data sources to assess a connectedness between users within an enterprise directory with users who are external to the directory. By utilizing private data sources that are only accessible to systems with the authorization to do so, examples of the disclosure can generate a more accurate measure of connectedness between users within the enterprise and external users. Examples of the disclosure can assess frequency of communication between a user in a directory and an external user, the last date of communication, whether the communication was directly with the external user or whether the communication was indirect. Examples of the disclosure can also rely on a sentiment analysis of the communications between users and external users. The above factors can be utilized to assess a degree of connectedness between users within the enterprise and external users.

A graph can be generated that expresses the connectedness between internal and external users. Nodes linking users can be weighted according to the degree of connectedness. The stronger a weighting of an edge connecting nodes can mean that the user is closer connected to the user. In some examples, a ranked list of users internal to the enterprise can be generated that ranks the user based upon a degree of connectedness with an external user or an external organization. By assessing the graph or a ranked list, examples of the disclosure can identify a user within an enterprise directory that is most closely connected to a particular external user or organization. Examples of the disclosure can generate a suggestion to leverage this user in attempting to connect with the external user or organization.

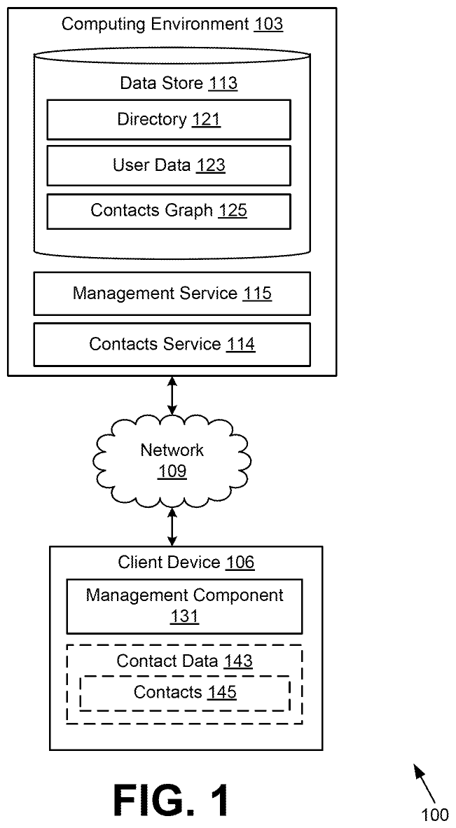

With reference to FIG. 1, shown is a networked environment 100 according to various embodiments. The networked environment 100 includes a computing environment 103 and a client device 106, which are in data communication with each other via a network 109. The network 109 includes, for example, the Internet, one or more intranets, extranets, wide area networks (WANs), local area networks (LANs), wired networks, wireless networks, other suitable networks, or any combination of two or more such networks. For example, such networks may comprise satellite networks, cable networks, Ethernet networks, telephony networks, and other types of networks.

The computing environment 103 can comprise, for example, a server computer or any other system providing computing capability. Alternatively, the computing environment 103 can employ a plurality of computing devices that can be arranged, for example, in one or more server banks, computer banks, or other arrangements. Such computing devices can be located in a single installation or can be distributed among many different geographical locations. For example, the computing environment 103 can include a plurality of computing devices that together can comprise a hosted computing resource, a grid computing resource, and/or any other distributed computing arrangement. In some cases, the computing environment 103 can correspond to an elastic computing resource where the allotted capacity of processing, network, storage, or other computing-related resources can vary over time. The computing environment 103 can also include or correspond to one or more virtualized server instances that are created in order to execute the functionality that is described herein.

Various applications or other functionality can be executed in the computing environment 103 according to various embodiments. Also, various data is stored in a data store 113 that is accessible to the computing environment 103. The data store 113 can be representative of a plurality of data stores 113 as can be appreciated. The data stored in the data store 113, for example, is associated with the operation of the various applications and/or functional entities described below.

The components executed on the computing environment 103, for example, can include a management service 115, contacts service 114, and other applications, services, processes, systems, engines, or functionality not discussed in detail herein. The management service 115 can manage and/or oversee the operation of multiple client devices 106. For example, an enterprise can operate the management service 115 to ensure that the client devices 106 that are enrolled as managed devices are operating in compliance with various compliance rules. By ensuring that the client devices 106 are operated in compliance with the compliance rules, the employer can control and protect access to various data. The management service 115 can also facilitate access to email, calendar data, contact information, documents, or other enterprise data to which an enterprise may wish to provide access by users via client devices 106.

In some embodiments, the management service 115 can also determine compliance of client devices 106 associated with a particular user with compliance rules in response to a request received from an application executed by a client device 106. The computing environment 103 can also execute other applications to facilitate interactions with a client device 106, such as an application distribution service that distributes applications and/or updates to applications to the client device 106, a mail server that provides email services and/or functionality, a document storage application that provides remote document storage capability for users of an enterprise, or other applications or services that an enterprise can deploy to provide services for its users. Description of such applications or services is not necessary for a complete understanding of embodiments of the disclosure.

The management service 115 can cause configuration profiles and other configuration data to be installed on a client device 106. For example, certificate profiles that provide a client device 106 with access to a certain network can be installed on the client device 106 by the management service 115. As another example, the management service 115 can push configuration profiles that include contacts or contact data to the client device 106. The management service 115 can rely upon management application programming interfaces (API's) provided by an operating system of the client device 106 that allows the management service 115 to remotely manage the client 106.

Examples of this disclosure can leverage the management capability provided by the operating system of the client device 106 to access resources on the client device 106 that can be analyzed to determine a degree of connectedness of users within the enterprise to external users or organizations. Additionally, the management service 115 can also access resources associated with users that are stored remotely from the client device 106 to perform such an analysis. For example, the users' email, text messages, other messaging service communications, conferencing service interactions, and other communications can be utilized to generate a contacts graph 125 that expresses how connected users are to one another and/or to external users.

The contacts service 114 can generate the contacts graph 125. The contacts service 114 can generate the contacts graph 125 based on an analysis of email, text messages, other messaging service communications, conferencing service interactions, and other communications can be utilized to generate a contacts graph 125 that expresses how connected users are to one another and/or to external users. The contacts service 114 can access these data sources utilizing capabilities or permissions granted by users or an enterprise administrator and perform an analysis to identify the connectedness among users within an enterprise directory and with users who are external to the directory.

The data stored in the data store 113 includes, for example, a directory 121, user data 123, a contacts graph 125 and potentially other data. The user data 123 can include data associated with a user account, such as user profile information. User profile information can include information about a user's role within an organization, an office address or location, home address or location, permissions, and/or privileges with respect to usage of an enterprise device.

User data 123 can also include access settings, such as authentication credentials, delegation settings (e.g., information about other users who may be provided access to the user data 123 of a particular user), mail and document retention rules and/or policies, and/or other geographic access restrictions or limitations (e.g., information about certain locations and/or networks from which user data 123 can be accessed). User data 123 can also include other account settings, such as biographical or demographic information about a user, password reset information, multi-factor authentication settings, authentication tokens, and other data related to a user account. User data 123 can also include other forms of data associated with users of an enterprise's computing resources that are not shown, such as a user's mailbox data, calendar data, contact data, and information about the various devices, such as device identifiers, that are assigned to the user and managed in some form by the management service 115. For example, mailbox data includes data associated with one or more mailboxes corresponding to a user account of a user.

Calendar data can include, for example, appointments, reminders, tasks and/or other data that can be associated with a timestamp or date stamp. Calendar data can include appointments that are associated with a particular location and/or user. For example, an appointment can be linked with a particular location, meeting room, building, address, or other location. An appointment can also be linked with another user who is internal or external to an organization or domain of the user as well as with text and/or attachments. Calendar data can also include tasks, reminders, or other types of data that can be associated with a time and/or place and placed on a calendar.

Contact data can include address book information related to contacts of a particular user such as internal or external email addresses, telephone contact information, mailing addresses, contact notes, and other information associated with contacts that a user may wish to maintain in an address book or contacts store. Contact data can also include user specific address book data as well as global address book data for address books that are shared among multiple users in a domain and/or enterprise. Contact data can be synchronized with a contacts database that is stored on the client device 106. In some examples, a client device 106 can be synchronized with other mailboxes, contacts, and/or calendars that are separate from an enterprise-provided account. For example, the operating system or an application on the client device 106 can allow a user to add a personal email account that is synchronized with a contacts database on the client device 106. The contacts database can be accessible to a phone application running on the client device 106 can handles the placing or receiving of voice calls. The phone application can access a contacts database on the client device 106 to render information about an incoming call by matching a phone number associated with the call to a contact in the contacts database on the client device 106.

User data 123 can also include authentication tokens or credentials that can enable the management service 115 or the contacts service 114 to access data sources associated with enterprise users. For example, the user data 123 can include a token or indication that the management service 115 or the contacts service 114 is authorized to access private data sources associated with users, such as email, text messages, other messaging service communications, conferencing service interactions, and other communications of the user to generate a contacts graph 125 according to examples of the disclosure.

User data 123 can include information about recent interactions with other users within or external to the enterprise. This information can be obtained by the contacts service 114 based upon an analysis of the email of the user, messaging interactions within messaging services provided by the enterprise, and interactions with others in conferencing services utilized by the enterprise.

User data 123 can also incorporate data from an organization hierarchy that can be determined from a directory 121 within the enterprise or an identity management service. User data 123 can also include data from email and messaging interactions within email and messaging services provided by the enterprise to its users. User data 123 can also include the identity of other users with which the user is likely to interact based on the user's role with an organization, such as a group within a directory service to which the user is assigned.

Directory 121 can comprise an enterprise directory that stores information about users, devices, physical locations, and other resources within an enterprise. The directory 121 can be hosted by a third party directory service, such as Microsoft Active Directory®. The directory 121 can group users within user groups within an organization. The directory 121 can also group users according to a reporting hierarchy so that user manager roles and subordinate roles are defined within the directory 121. The directory 121 can also uniquely identify, users within the enterprise relative to other users.

The contacts graph 125 represents a graph data structure that expresses the connectedness between internal and external users. Nodes linking users can be weighted according to the degree of connectedness. The stronger a weighting of an edge connecting nodes can mean that the user is closer connected to the user. In some examples, a ranked list of users internal to the enterprise can be generated that ranks the user based upon a degree of connectedness with an external user or an external organization. By assessing the graph or a ranked list, examples of the disclosure can identify a user within an enterprise directory that is most closely connected to a particular external user or organization. Examples of the disclosure can generate a suggestion to leverage this user in attempting to connect with the external user or organization.

In some examples of the disclosure, an alternative data structure can be selected rather than a graph data structure to express the connectedness of users.

The client device 106 is representative of a plurality of client devices that can be coupled to the network 109. The client device 106 can comprise a computing device. Such a computing device can be embodied in the form of a desktop computer, a laptop computer, a personal digital assistant, a cellular telephone, a smartphone, or any other device with like capability. The client device 106 can include a display that comprises, for example, one or more devices such as liquid crystal display (LCD) displays, organic light emitting diode (OLED) displays, or other types of display devices.

The client device 106 can be configured to execute various applications, such as a management component 131. The management component 131 can be executed by the client device 106 upon startup of the client device 106. The management component 131 can also be executed as a background process by the client device 106. The management component 131 can be installed with elevated privileges on the client device 106 and have elevated rights to install profiles, certificates and/or oversee the operation of the client device 106 on behalf of the management service 115. The management component 131 can be installed by a user and/or device administrator and facilitate access to user data 123 by a user of the client device 106. For example, the management component 131 can be executed by a user to facilitate provisioning of a device and/or configuration of software to facilitate access to user data 123 and/or other enterprise resources.

Contact data 143 can also be stored on the client device 106. In some embodiments, contact data 143 can be obtained from the computing environment 103 by the management component 131 or other application or service executed by the client device 106. In some examples, contact data 143 and can be synchronized with user data 123 corresponding to a user associated with the client device 106. The contact data 143 can also be synchronized with a third email service utilized by the enterprise or an email service with which the user has synchronize the client device 106, such as a personal email account.

A contact 145 can be an entry within the contact data 143. A contact 145 can include information about a contact, such as a first name, last name, phone number, email address, and other contact identifiers. The phone application 133 and messaging application 135 can rely upon contact data 143 to display identifying information from a contact 145 about incoming or outgoing calls or messages. The information can include a contact's name or other identifying information.

The management component 131 can report messaging, calling, conferencing or other activity of a user to the management service 115 or the contacts service 114. The various applications installed on the client device 106 can also directly report user activity to the management service 115 or contacts service 114. The management component 131 can be installed as a device administrator with elevated privileges that are supported by an operating system of the client device 106. The elevated privileges can allow the management component 131 with access to user activity in various communication applications. In some examples, the management component 131 can be provided with access to user activity within communication applications as a user opt-in feature.

User activity within communication applications and services can also be obtained by the management service 115 and/or contacts service 114 by accessing network-accessible application programming interfaces (API's) that enable access to user activity. The API's can provide cloud-based access to user activity with appropriate authentication or access tokens to the API's. The API's can allow for a user or administrator to enable access to user activity within a particular communication service. For example, a cloud-based messaging service can allow a third party service, such as the contacts service 114 and the management service 115 to access user activity. The user activity, for example, can be ingested by the contacts service 114 and analyzed to create or augment a contacts graph 125 that expresses connectedness between users and/or external user or organizations.

Accordingly, the contacts service 114 can generate a contacts graph 125 that can be utilized by applications and services to provide a recommendation for a user within a user's organization for a someone who can facilitate a connection with an external user or organization. The external user or organization can represent a contact in an organization external to the enterprise. For example, the external user can represent a sales prospect or a potential collaborator. The external user can also represent an organization, such as a different company or entity with which a user is seeking to connect.

The contacts service 114 can provide a recommendation to a user requesting a connection to an external user. The recommendation can comprise a user within the enterprise, such as another user within the directory 121, that the contacts service 114 has determined is a closest connection to the external user based upon an analysis of user communications with the external user. The analysis can be based on an analysis of emails, messaging, chats, conferencing, and other private data sources to assess a connectedness between users within an enterprise directory with users who are external to the directory 121.

The analysis can take into account a frequency of communication with the external user, a recency of communication with the external user, and a sentiment analysis of communication with the external user. The contacts graph 125 can connect users to one another with weighted edges that are weighted based upon a connectedness between a user and the external user. A higher weighted edge connecting a user with an external user can indicate a greater degree of connectedness with the external user than a different user connected to the external user with a lower weighted edge.

The contacts service 114 can generate the contacts graph 125 by analyzing communications with the external user by users within the directory 121. For each user who has communicated with the external user, the contacts graph 125 can generate a score, or a weighting, that expresses a degree of connectedness with the external user. The data sources can be analyzed to assess the frequency of communication with the external user, the age of communication with the external user, and a sentiment analysis that can be performed on communications with the external user. Regarding frequency of communications, the more recent that a user has communication with the external user, the closer that the connectedness between the user and the external user are considered to be. Regarding age of communication, an average age of communication between the user and the external user can also be considered. The more recent that an average age of communication with the external user, the closer that the connectedness between the user and the external user are considered to be.

Regarding sentiment analysis, a first quantitative output from the sentiment analysis of a first user that indicates a more positive emotion is associated with a closer contact with the external user than a second quantitative output from the sentiment analysis of a second user indicating a less positive emotion. The sentiment analysis can be performed on all communications and a total quantitative output can be determined. Alternatively, the sentiment analysis can be performed on a subset of the communications, such as the most recent communications or a sampling of the communications between the users in the directory 121 and the external user.

Based upon the insights derived from the analysis in communications, or from the data sources accessible the contacts graph 125, a ranking can be generated that ranks the strength of the connection based on frequency, sentiment, and/or age of communication with the external user. The ranking can be a ranking of users in the directory 121 in terms of their respective connectedness with the external user. The closest connection to an external user can be a highest ranked user in the directory 121 according to the ranking based upon the analysis of the data sources associated with the user that involve communication with the external user.

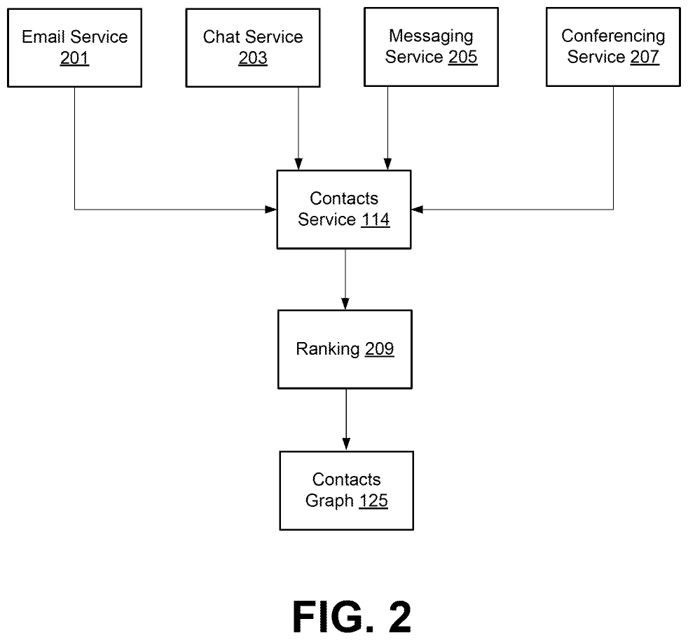

To illustrate a scenario, reference is made to FIG. 2, which illustrates data flow according to examples of the disclosure. In the example shown in FIG. 2, various data sources are accessible to the contacts service 114. For example, user data 123 that is stored internal to the enterprise or external to the enterprise can be accessed by the contacts service 114. As noted above, the management component 131 can report messaging, calling, conferencing or other activity of a user to the management service 115 or the contacts service 114. The various applications installed on the client device 106 can also directly report user activity to the management service 115 or contacts service 114. The management component 131 can be installed as a device administrator with elevated privileges that are supported by an operating system of the client device 106. The elevated privileges can allow the management component 131 with access to user activity in various communication applications. In some examples, the management component 131 can be provided with access to user activity within communication applications as a user opt-in feature.

Additionally, the contacts service 114 can be provided with an authentication token or other authority to access private data sources that store user data to analyze and create a contacts graph 125. In some cases, certain user activity or user data might be stored on a network accessible server or device that is accessed using an API. Accordingly, the contacts service 114 can collect user data from the various data sources to generate the contacts graph 125 via these API's in addition or as an alternative to obtaining user data from a client device 106.

Accordingly, as shown in FIG. 2, example user data, such as email from an email service 201, chats from a chat service 203, messages from a messaging service 205, or conferencing activity from a conferencing service 207. The data from the data sources, which are private data sources that are inaccessible to a social networking site, for example, can be ingested by the contacts service 114 and analyzed to generate the contacts graph 125.

The analysis can take into account a frequency of communication with the external user, a recency of communication with the external user, and a sentiment analysis of communication with the external user. The contacts graph 125 can connect users to one another with weighted edges that are weighted based upon a connectedness between a user and the external user. A higher weighted edge connecting a user with an external user can indicate a greater degree of connectedness with the external user than a different user connected to the external user with a lower weighted edge.

The contacts service 114 can generate the contacts graph 125 by analyzing communications with the external user by users within the directory 121. For each user who has communicated with the external user, the contacts graph 125 can generate a score, or a weighting, that expresses a degree of connectedness with the external user. The data sources can be analyzed to assess the frequency of communication with the external user, the age of communication with the external user, and a sentiment analysis that can be performed on communications with the external user. Regarding frequency of communications, the more recent that a user has communication with the external user, the closer that the connectedness between the user and the external user are considered to be. Regarding age of communication, an average age of communication between the user and the external user can also be considered. The more recent that an average age of communication with the external user, the closer that the connectedness between the user and the external user are considered to be.

In some examples of the disclosure, the analysis can be based upon real-world dynamic scenarios and not be restricted to static scenarios such as an analysis of static user data. For example, consider the scenario of an expo or an event with live attendees. With potentially thousands of delegates at an event, contacting a prospect face-to-face is much more likely. In such a scenario, examples of the disclosure can also work in a dynamic mode wherein when a user can search for an external user at a different enterprise. The results can be shown to the user and ordered based on not just relevance but also upon based the contacts graph 125 or a ranking that is generated based upon those other users within the directory 121 who are in proximity to the user at the current moment. The proximity of other users from the directory 121 can be detected from a location detected by a management component 131 on the respective users' client devices 106.

Examples of the disclosure can also detect a current location of the user and offer them suggestions another user within proximity of the user who can potentially be of assistance to them in connecting with an external user.

In some examples, the contacts service 114 can generate a ranking 209 of users according to their connectedness to an external user. In some examples, a ranked list of users internal to the enterprise can be generated that ranks the user based upon a degree of connectedness with a particular external user or a particular external organization. By assessing the graph or a ranked list, examples of the disclosure can identify a user within an enterprise directory that is most closely connected to a particular external user or organization. Examples of the disclosure can generate a suggestion to leverage this user in attempting to connect with the external user or organization.

The contacts service 114 can also generate a contacts graph 125. The contacts service 114 can generate the contacts graph 125 based on an analysis of email, text messages, other messaging service communications, conferencing service interactions, and other communications can be utilized to generate a contacts graph 125 that expresses how connected users are to one another and/or to external users. The contacts service 114 can access these data sources utilizing capabilities or permissions granted by users or an enterprise administrator and perform an analysis to identify the connectedness among users within an enterprise directory and with users who are external to the directory.

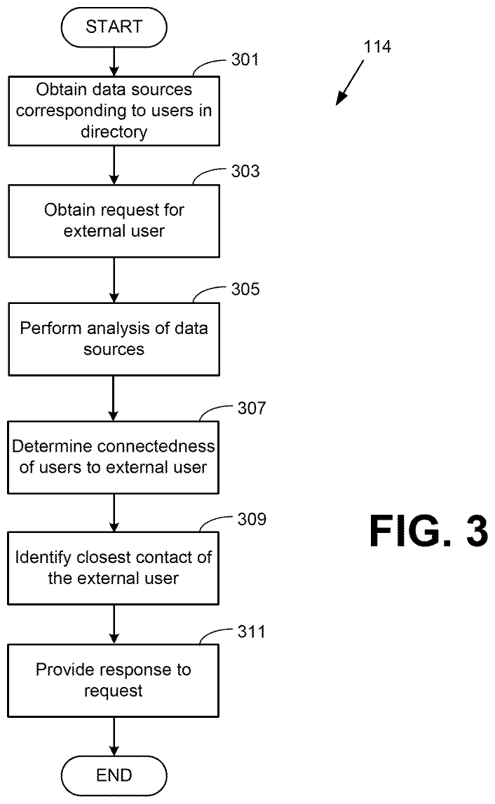

Referring next to FIG. 3, shown is a flowchart that provides one example of the operation of a portion of the contacts service 114 according to various embodiments. It is understood that the flowchart of FIG. 3 provides merely an example of the many different types of functional arrangements that may be employed to implement the operation of the portion of the contacts service 114. As an alternative, the flowchart of FIG. 3 may be viewed as depicting an example of elements of a method implemented in the computing environment 103 according to one or more embodiments. Additionally, it should be appreciated that the functionality shown as implemented by the contacts service 114 can also be implemented by the management service 115 or other services or applications.

First, at step 301, the contacts service 114 can obtain data sources corresponding to users in a directory 121. For example, user data 123 that is stored internal to the enterprise or external to the enterprise can be accessed by the contacts service 114. As noted above, the management component 131 can report messaging, calling, conferencing or other activity of a user to the management service 115 or the contacts service 114. The various applications installed on the client device 106 can also directly report user activity to the management service 115 or contacts service 114. The management component 131 can be installed as a device administrator with elevated privileges that are supported by an operating system of the client device 106. The elevated privileges can allow the management component 131 with access to user activity in various communication applications. In some examples, the management component 131 can be provided with access to user activity within communication applications as a user opt-in feature.

Additionally, the contacts service 114 can be provided with an authentication token or other authority to access private data sources that store user data to analyze and create a contacts graph 125. In some cases, certain user activity or user data might be stored on a network accessible server or device that is accessed using an API. Accordingly, the contacts service 114 can collect user data from the various data sources to generate the contacts graph 125 via these API's in addition or as an alternative to obtaining user data from a client device 106.

At step 303, the contacts service 114 can obtain a request for a connection to an external user. The request can comprise a request to identify a closest contact of the external user. The closest contact can be one that is a highest ranked user in terms of connectedness with the external user based upon an analysis of the data sources performed by the contacts service 114 and/or the contacts graph 125 generated by the contacts service 114.

At step 305, the contacts service 114 can perform the analysis of the data sources obtained in step 301. The users' email, text messages, other messaging service communications, conferencing service interactions, and other communications can be utilized to generate a contacts graph 125 that expresses how connected users are to one another and/or to external users. The data sources can be analyzed to assess the frequency of communication with the external user, the age of communication with the external user, and a sentiment analysis that can be performed on communications with the external user. Regarding frequency of communications, the more recent that a user has communication with the external user, the closer that the connectedness between the user and the external user are considered to be. Regarding age of communication, an average age of communication between the user and the external user can also be considered. The more recent that an average age of communication with the external user, the closer that the connectedness between the user and the external user are considered to be.

Regarding sentiment analysis, a first quantitative output from the sentiment analysis of a first user that indicates a more positive emotion is associated with a closer contact with the external user than a second quantitative output from the sentiment analysis of a second user indicating a less positive emotion. The sentiment analysis can be performed on all communications and a total quantitative output can be determined. Alternatively, the sentiment analysis can be performed on a subset of the communications, such as the most recent communications or a sampling of the communications between the users in the directory 121 and the external user.

Based upon the insights derived from the analysis in communications, or from the data sources accessible the contacts graph 125, a ranking can be generated that ranks the strength of the connection based on frequency, sentiment, and/or age of communication with the external user. The ranking can be a ranking of users in the directory 121 in terms of their respective connectedness with the external user. The closest connection to an external user can be a highest ranked user in the directory 121 according to the ranking based upon the analysis of the data sources associated with the user that involve communication with the external user.

At step 307, the contacts service 114 can determine connectedness of the users in the directory 121 to the requested external user. In one example, a ranking can be generated from the contacts graph 125 that ranks the connectedness of users from the directory 121 to the external user or organization.

At step 309, the contacts service 114 can identify the closest contact from the directory 121 in relation to the external user or organization. The closest contact can comprise a highest ranked user or a user from the contacts graph 125 connected to the external user with a highest weighted edge connecting the user to the external user.

At step 311, the contacts service 114 can provide a response to the request for a connection to the external user. The response can comprise an identity of the user from the directory 121 that is the closest contact or closest connection to the external user. Thereafter, the process can proceed to completion.

Although the contacts service 114, management service 115, management component 131, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 3 shows an example of the functionality and operation of an implementation of portions of the contacts service 114. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 can be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including contacts service 114, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the contacts service 114, management service 115, management component 131, etc., can be implemented and structured in a variety of ways. For example, one or more applications described can be implemented as modules or components of a single application. Further, one or more applications described herein may be executed in shared or separate computing devices or a combination thereof. For example, a plurality of the applications described herein may execute in the same computing device and/or client device 106, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It is emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

What is claimed is:

1. A non-transitory computer-readable medium embodying instructions executable by at least one processor, the instructions causing the at least one processor to at least:
obtain a plurality of data sources associated with a plurality of users in a directory, the directory comprising an enterprise user directory with a plurality of users;
obtain a request for an external user that is external to the directory;
perform an analysis of the data sources associated with the plurality of users in the directory by determining a connectedness of the plurality of users in the directory based upon frequency of communication with the external user;
identify a closest contact of the external user from the user directory; and
generate a response to the request, wherein the response to the request comprises the closest contact.

2. The non-transitory computer-readable medium of claim 1, wherein the instructions perform the analysis by determining the connectedness based upon an age of communication with the external user.

3. The non-transitory computer-readable medium of claim 1, wherein the instructions perform the analysis by determining the connectedness based upon a sentiment analysis of communication with the external user, wherein a first quantitative output from the sentiment analysis of a first user that indicates a more positive emotion is associated with a closer contact than a second quantitative output from the sentiment analysis of a second user indicating a less positive emotion.

4. The non-transitory computer-readable medium of claim 1, wherein the plurality of data sources comprises emails exchanged between a respective user and the external user.

5. The non-transitory computer-readable medium of claim 1, wherein the plurality of data sources comprises previous interactions between a respective user with the external user via a messaging service or a conferencing service.

6. The non-transitory computer-readable medium of claim 1, wherein the instructions perform the analysis by determining the connectedness by generating a graph data structure, wherein a subset of a plurality of nodes of the graph structure correspond to users from the directory and a first node of the plurality of nodes corresponds to the external user.

7. The non-transitory computer-readable medium of claim 6, wherein edges between the plurality of nodes represent connectedness between users, wherein the edges are weighted based upon a degree of connectedness determined by the analysis of the data sources.

8. A system, comprising:
at least one computing device; and
an application executable by the at least one computing device, the application causing the at least one computing device to at least:
obtain a plurality of data sources associated with a plurality of users in a directory, the directory comprising an enterprise user directory with a plurality of users;
obtain a request for an external user that is external to the directory;
perform an analysis of the data sources associated with the plurality of users in the directory by determining a connectedness of the plurality of users in the directory based upon frequency of communication with the external user;
identify a closest contact of the external user from the user directory; and
generate a response to the request, wherein the response to the request comprises the closest contact.

9. The system of claim 8. wherein the instructions perform the analysis by determining the connectedness based upon an age of communication with the external user.

10. The system of claim 8, wherein the instructions perform the analysis by determining the connectedness based upon a sentiment analysis of communication with the external user, wherein a first quantitative output from the sentiment analysis of a first user that indicates a more positive emotion is associated with a closer contact than a second quantitative output from the sentiment analysis of a second user indicating a less positive emotion.

11. The system of claim 8, wherein the plurality of data sources comprises emails exchanged between a respective user and the external user.

12. The system of claim 8, wherein the plurality of data sources comprises previous interactions between a respective user with the external user via a messaging service or a conferencing service.

13. The system of claim 8, wherein the instructions perform the analysis by determining the connectedness by generating a graph data structure, wherein a subset of a plurality of nodes of the graph structure correspond to users from the directory and a first node of the plurality of nodes corresponds to the external user.

14. The system of claim 13, wherein edges between the plurality of nodes represent connectedness between users, wherein the edges are weighted based upon a degree of connectedness determined by the analysis of the data sources.

15. A method, comprising:
obtaining a plurality of data sources associated with a plurality of users in a directory, the directory comprising an enterprise user directory with a plurality of users;
obtaining a request for an external user that is external to the directory;
performing an analysis of the data sources associated with the plurality of users in the directory by determining a connectedness of the plurality of users in the directory based upon frequency of communication with the external user;
identifying a closest contact of the external user from the user directory; and
generating a response to the request, wherein the response to the request comprises the closest contact.

16. The method of claim 15, further comprising performing the analysis by determining the connectedness based upon an age of communication with the external user.

17. The method of claim 15, further comprising performing the analysis by determining the connectedness based upon a sentiment analysis of communication with the external user, wherein a first quantitative output from the sentiment analysis of a first user that indicates a more positive emotion is associated with a closer contact than a second quantitative output from the sentiment analysis of a second user indicating a less positive emotion.

18. The method of claim 15, wherein the plurality of data sources comprises emails exchanged between a respective user and the external user.

19. The method of claim 15, further comprising performing the analysis by determining the connectedness by generating a graph data structure, wherein a subset of a plurality of nodes of the graph structure correspond to users from the directory and a first node of the plurality of nodes corresponds to the external user.

20. The method of claim 19, wherein edges between the plurality of nodes represent connectedness between users, wherein the edges are weighted based upon a degree of connectedness determined by the analysis of the data sources.
